(19) United States
(12) Patent Application Publication
(10) Pub. No.: US 2004/0065166 A1
(43) Pub. Date: Apr. 8, 2004

(54) Automobile gearshift lock

(76) Inventor: Hui-Hua Hsieh, Chung Ho City (TW)

Correspondence Address: Hui-Hua Hsieh, P.O. Box 90, Tainan City, 704, TW

(21) Appl. No.: 10/261,468

(22) Filed: Oct. 2, 2002

(51) Int. Cl. G05G 1/04

(52) U.S. Cl. 74/523

(57) ABSTRACT

An automobile gearshift lock includes a fixing base and a protective cover. The fixing base is secured with the gear lever, provided with an insert groove and a lock core holder for receiving a lock core with a resilient projection. The protective cover is fixed with the fixing base, provided with a protruding-out portion and a shielding plate extending downward to be inserted in the insert groove. The shielding plate has an engage slot for the resilient projection to be engaged therein. In locking, the protective cover has its protruding-out portion exactly covering the knob of the gearshift and its shielding plate is inserted into the insert groove of the fixing base, convenient in operating. Besides, the screwed portion of the fixing base and the gear lever are shielded by the shielding plate, having excellent effect of anti-theft.

### BACKGROUND OF THE INVENTION

1. Field of the Invention

This invention relates to an automobile gearshift lock of an automobile, particularly to one composed of a fixing base and a protective cover. The fixing base is threadably fixed with the gearshift and the protective cover is fixed together with the fixing base. To lock the gearshift, it only needs to have the upper portion of the protective cover fitted around the knob of the gearshift and its lower portion inserted in the vertical insert groove of the fixing base, convenient in operating and using. Besides, the screwed portion of the fixing base and the gearshift is shielded by the shielding plate of the protective cover to avoid being destroyed, having excellent effect of anti-theft.

2. Description of the Prior Art

Generally, the gearshift 10 of a car with an automatic shifter, as shown in FIG. 1, is provided with a press button 101 at one side of its knob 100, which is secured on the gearshift 10 by a bolt 102 screwing through a preset threaded hole 103 of the gear lever 10. During gear shifting, the press button 101 has to be first pressed in order to carry out changeover of gears.

A conventional automobile gearshift lock 11 is provided with a lock base 110 threadably assembled on one side of a gear base 12 and has its U-shaped shackle 111 clasping the gear lever 10 immovable to reach a purpose of anti-theft. However, the lock base 110 of the conventional automobile gearshift lock 11 assembled on one side of the gear base 12 is liable to hamper operation of gear shifting and easy to be illegally disassembled by a burglar.

### SUMMARY OF THE INVENTION

The objective of the invention is to offer an automobile gearshift lock, convenient in operating, having an assembled portion shielded by a shielding plate to avoid being destroyed, having excellent effect of anti-theft, and impossible to hamper operation of gear shifting.

The feature of the invention is a fixing base threadably secured with a gearshift. The fixing base is provided with a vertical insert groove at one side and a lock core hole at a proper location for receiving a lock core having a resilient projection. The fixing base is further bored with at least one through hole aligned to the preset threaded holes of the gearshift. A protective cover to be fitted around the knob of the gearshift and assembled with the fixing base is formed with a protruding-out portion at the upper side, a shielding plate extending downward to be inserted in the vertical insert groove of the fixing base and an engage slot bored at a proper location of the shielding plate for receiving the resilient projection of the lock core.

### BRIEF DESCRIPTION OF DRAWINGS

This invention will be better understood by referring to the accompanying drawings, wherein:

FIG. 1 is a perspective view of a conventional automobile gearshift lock locked on a gearshift;

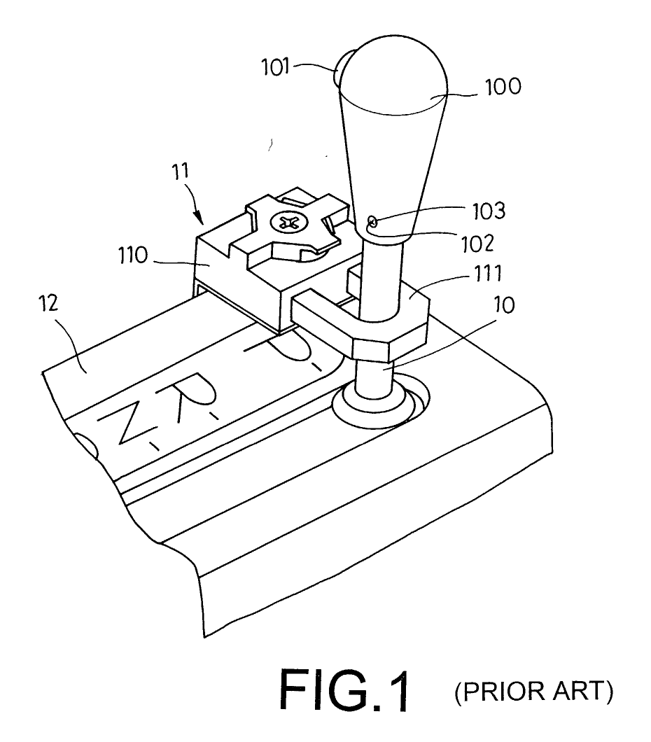

FIG. 2 is an exploded perspective view of an automobile gearshift lock in the present invention;

FIG. 3 is a perspective view of the automobile gearshift lock locked on a gearshift in the present invention;

FIG. 4 is a cross-sectional view of the automobile gearshift lock locked on the gearshift in the present invention; and,

FIG. 5 is a side-sectional view of the automobile gearshift lock locked on the gearshift in the present invention.

### DETAILED DESCRIPTION OF THE PREFERRED EMBODIMENT

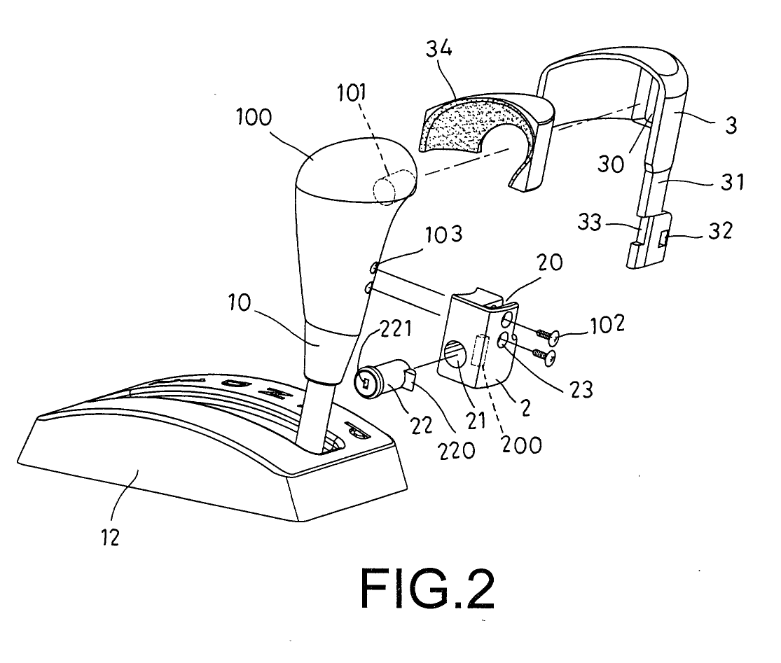

A preferred embodiment of an automobile gearshift lock in the present invention, as shown in FIG. 2, includes a fixing base 2 and a protective cover 3 combined together.

The fixing base 2 to be firmly assembled with a gearshift is bored at one side with a vertical insert groove 20 having an engage block 200 at a proper location on the inner wall. The fixing base 2 is also provided with a lock core hole 21 at a proper position of the opposite side of the insert groove 20 for receiving a lock core 22 therein. The lock core 22 is provided at a front side with a retractable resilient projection 220 extending into the insert groove 20 of the fixing base 2 and a keyhole 221 in an outer end. The fixing base 2 is further bored with two through fish eye holes 23 at an upper side to be screwed together with the preset threaded holes 103 of the gearshift 10 by means of bolts 102.

The protective cover 3 to cover the knob 100 of the gear lever 10 and be fitted with the fixing base 2 has a protruding-out portion 30 at an upper side to align to the press button 101 of the gear lever 10, a shielding plate 31 extending downward to be inserted in the vertical insert groove 20 of the fixing base 2, and an engage slot 32 and a notch 33 at proper locations respectively for the resilient projection 220 of the lock core 22 and the engage block 200 in the vertical insert groove 20 to be engaged therein. Besides, the protective cover 3 has a soft pad 34 closely attached on an inner wall to protect the surface of the gearshift knob 100 from being worn off.

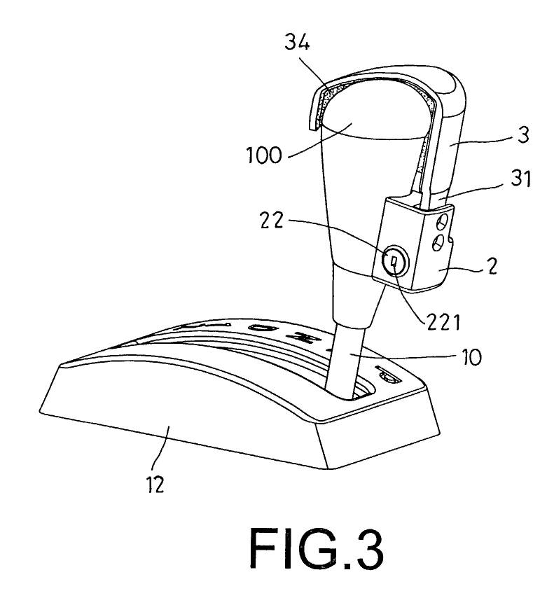

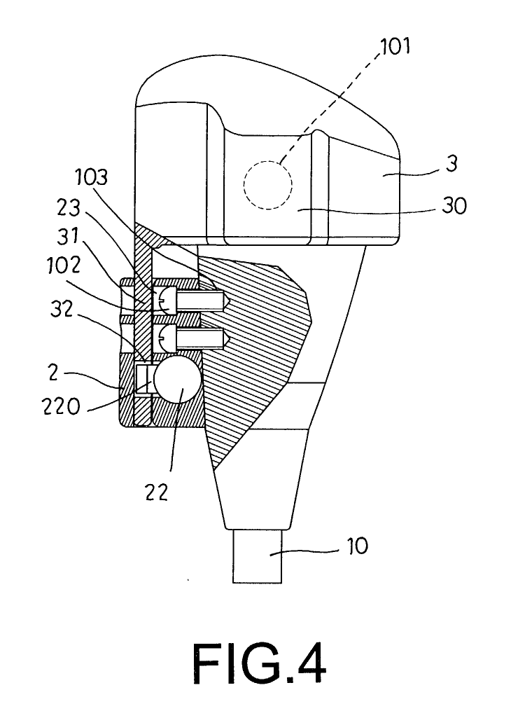

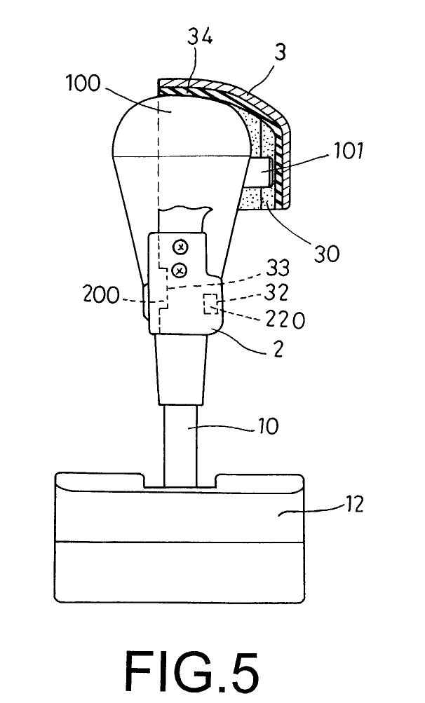

In assembling, as shown in FIGS. 2-5, the lock core 22 is first received in the lock core hole 21 of the fixing base 2, letting the resilient projection 220 extend in the insert groove 20. Next, the fixing base 2 is firmly secured on the gearshift 10 by bolts 102 screwing through the through holes 23 of the fixing base 2 and the threaded holes 103 of the gearshift 10.

To lock the gearshift 10, the protective cover 3 is positioned to have its protruding-out portion 30 exactly covering up the press button 101 of the gearshift 10 and its shielding plate 31 inserted in the vertical insert groove 20 of the fixing base 2, letting the notch 33 of the shielding plate 31 engaged with the engage block 200 on the inner wall of the vertical insert groove 20 and the resilient projection 220 of the lock core 22 received in the engage slot 32 of the shielding plate 31, which exactly shields the bolts 102. Under this circumstance, the press button 101 of the gearshift 10 is covered by the protective cover 3 so the gearshift 10 can no longer be operated and the bolts 102 screwing the fixing base 2 and the gear lever 10 together are shielded by the shielding plate 31 so they are impossible to be destroyed, thus achieving substantive effect of anti-theft. On the contrary, to unlock, simply insert a key into the key hole 221 of the lock core 22 and turn it around to force the resilient projection 220 to retract inward and be disengaged from the engage slot 32 of the protective cover 3, and then remove the protective cover 3 from the fixing base 2 to allow the gearshift 10 to function normally.

To sum up, this invention has the following advantages.

1. When the automobile gearshift lock is to be locked, it only needs to hold the protective cover 3 with a single hand to have its protruding-out portion fitted around the gearshift knob 100 and its shielding plate 31 inserted in the vertical insert groove 20 of the fixing base 2, convenient in operating and using.

2. The shielding plate 31 of the protective cover 3 engages in the vertical insert groove 20 of the fixing base 2 and shields the location of the bolts 102, having excellent effect of anti-theft.

3. The fixing base 2 is assembled on the gearshift 10 so it does not hamper operation of gear shifting at all.

While the preferred embodiment of the invention has been described above, it will be recognized and understood that various modifications may be made therein and the appended claims are intended to cover all such modifications that may fall within the spirit and scope of the invention.

What is claimed is:

1. An automobile gearshift lock comprising:
a fixing base threadably assembled with a gearshift, said fixing base bored with a vertical insert groove at one side, said fixing base provided with a lock core hole at a proper location for receiving a lock core, said lock core provided with a retractable resilient projection at a front side, said fixing base further bored with at least one through hole, said through hole aligned to a preset threaded hole of said gearshift;
a projective cover covering up the knob of said gearshift and fitted with said fixing base, said protective cover formed with a protruding-out portion at one side, said protective cover having a shielding plate formed in its lower portion extending downward, said shielding plate inserted in said vertical insert groove of said fixing base, said shielding plate bored with an engage slot at a proper position, said engage slot receiving therein said resilient projection of said lock core; and,
said protective cover held by a single hand and fitted around the knob of said gear lever in case of locking said gearshift, said shielding plate of said protective cover inserted in said vertical insert groove of said fixing base to finish locking of said gearshift, said shielding plate shielding the screwed portion of said fixing base and said gear lever, said shielding portion preventing said screwed portion from being destroyed.

2. The automobile gearshift lock as claimed in claim 1, wherein at least one engage block is fixed at a proper location on the inner wall of said vertical insert groove of said fixing base and at least one notch is bored at a proper location of one side of said shielding plate for said engage block to be inserted therein.

3. The automobile gearshift lock as claimed in claim 1, wherein said protective cover has a soft pad closely attached on an inner wall to protect the surface of said gearshift knob from being worn off.
